(19) United States
(12) Patent Application Publication
(10) Pub. No.: US 2007/0157517 A1
(43) Pub. Date: Jul. 12, 2007

(54) Single stage membrane reactor for high purity hydrogen production

(76) Inventors: David Tsay, Boston, MA (US); Steven E. Weiss, Cambridge, MA (US); Tom C. Tsay, San Marino, CA (US)

Correspondence Address: David Silverstein;Andover-IP-Law, 44 Park Street Suite 300, Andover, MA, 01810, US

(21) Appl. No.: 10/588,575

(22) PCT Filed: Feb. 4, 2005
(86) PCT No.: PCT/US05/03792

§ 371 Date: Aug. 3, 2006

Related U.S. Application Data
(60) Provisional application No. 60/542,569, filed on Feb. 6, 2004.

(51) Int. Cl. C01B 3/24

(52) U.S. Cl. 48/198.1; 48/127.9

(57) ABSTRACT

Hydrogen generating method and apparatus. The apparatus comprises a mixed phase protonic-electron conducting cermet membrane (2), wherein said membrane is coated with porous metal or composite catalyst (1) effective to decompose hydro-carbon and water reactants into a hydrogen-rich syngas at elevated temperature and pressure. The hydrogen ions are continuously withdrawn in situ by diffusing them through the mixed phase conducting cermet membrane (2) to the second membrane side where the hydrogen ions can be reconstituted into molecular hydrogen with a supply of electrons. The method favorably shifts the equilibrium of steam reforming and water gas shift reaction by use a single stage, high efficiency and high purity membrane reactor.

### FIELD OF INVENTION

This invention relates generally to a hydrogen manufacturing process and to related apparatus utilizing a catalyst-coated protonic-electron mix conducting cermet membrane to form a one-stage fuel reforming, water-gas-shift, and hydrogen purification system.

### BACKGROUND OF THE INVENTION

Hydrogen forming reaction systems, such as steam/methane reforming (wherein methane and water are reacted to form carbon monoxide, and carbon dioxide and hydrogen) and water-gas-shift reaction systems (wherein carbon monoxide is reacted with water to form carbon dioxide and hydrogen), are well known to the art.

Steam/methane reforming is typically used as a catalytic reaction system for the production of hydrogen. Conventional catalytic systems for steam/methane reforming require primary catalytic reaction temperatures on the order of 650 degrees C. and above, followed by rather extensive and expensive purification processes to provide a hydrogen product suitably pure to be used as a feed stock for many common processes. Catalytic steam/methane reforming processes as currently used are summarized in Kirk-Othmer Encyclopedia of Chemical Technology, Third Edition, Vol. 12, John Wiley & Son, pages 944, 950-95, which is incorporated herein by reference.

The water-gas-shift reaction is an alternative hydrogen production technology frequently used following the primary catalytic reaction to remove carbon monoxide impurities and increase hydrogen yield. The water-gas-shift reaction is mildly exothermic and thus is thermodynamically favored at lower temperatures. However, the kinetics of the reaction are superior at higher temperatures. Thus, it is common practice to first cool the reformate product from the steam reformer in a heat exchanger to a temperature between about 350 degrees C. and 500 degrees C., and then to conduct the reaction over a catalyst composed of finely divided oxides of iron and chromium formed into tablets. The resulting reformate gas is then cooled once again to a temperature between about 200 degrees C. and 250 degrees C. and reacted over a catalyst based upon mixed oxides of copper and nickel. A review of current applications and processes for such water-gas-shift reactions is found in Kirk-Othmer Encyclopedia of Chemical Technology, Third Edition, Vol. 12, John Wiley & Sons, pages 945, 951-952, which is incorporated herein by reference.

It is also known to use hydrogen ion conductive metal foils or molecular hydrogen permeable metal membranes such as palladium or palladium alloys to withdraw hydrogen in situ from the hydrogen forming reaction to permit the use of higher temperatures and the higher yielding water-gas-shift reaction, as described for example in U.S. Pat. No. 4,810,485, U.S. Pat. No. 5,997,597 and U.S. Pat. No. 6,033,634, which are incorporated herein by reference. These patents teach the use of hydrogen transport metal foils or porous metallic membranes for separating and conducting hydrogen in contact with and independent of the catalytic reaction system, but they do not describe or suggest a process or apparatus capable of integrating the reforming reaction, water-gas-shift reaction, and gas purification into a coordinated unitized system. Further, metallic membranes, in particular palladium or palladium alloys, are expensive, sensitive to sulfur compounds, and difficult to co-sinter with or sinter onto a catalyst layer. A more economical and stable solution is provided by dense protonic ceramic membranes.

The use of dense protonic ceramic membranes for hydrogen separation and purification is also known in the art. For example, U.S. Pat. No. 6,296,687, U.S. Pat. No. 6,235,417 and U.S. Pat. No. 5,821,185, which are incorporated herein by reference, describe the use of single-phase and mixed-phase perovskite-type oxidic protonic ceramic membranes for separating or decomposing hydrogen-containing gases or other such compounds to yield higher value products, but they do not describe or suggest a process or apparatus comprising a one-step hydrocarbon to hydrogen reforming reaction, water-gas-shift reaction, and gas purification combined and efficiently integrated into a unitized system. The teachings of these patents also do not describe or suggest methods to lower the sintering temperature of the protonic ceramic membrane to allow for lower manufacturing costs. These and other deficiencies in or limitations of the prior art are overcome in whole or at least in part by the single stage membrane reactors and related methods of this invention.

### OBJECTS OF THE INVENTION

Accordingly, it is a principal object of this invention to integrate a reformation catalyst and protonic-electron conduction cermet membrane into a hydrogen forming reaction system to promote hydrogen generation and to facilitate withdrawal in situ of such produced hydrogen.

Another object of this invention is to provide a reformation reaction adapted for in situ withdrawal of hydrogen to improve the water-gas-shift and reforming reaction equilibrium.

Yet another object of this invention is to provide hydrogen forming reaction processes which produce substantially pure hydrogen without the need for conventional water-gas-shift and chemical purification systems.

It is still another object of this invention to provide a water-gas-shift hydrogen forming reaction system adapted to operate efficiently at higher temperatures than conventional water-gas-shift reaction processes.

Still another object of this invention is to provide a membrane reactor support design and related enclosure structure which facilitates high pressure operation and affords the ability to utilize thin catalyst-membrane subassemblies.

A further object of this invention is to provide a method for protonic-electron conducting cermet membrane fabrication that is compatible with silicon carbide element furnaces by lowering the sintering temperature to about 1500 degrees C.

These and other objects, advantages and benefits of this invention will be better understood by the following description read in conjunction with FIGS. 1A and 1B, FIGS. 2A, 2B and 2C, and FIGS. 3A and 3B.

### SUMMARY OF THE INVENTION

The present invention relates generally to a solid state membrane reactor for producing high purity hydrogen by reacting an alcohol or a hydrocarbon feed with steam in the presence of a reformation catalyst and thereafter withdrawing the hydrogen or hydrogen ions produced in situ from the reaction zone through a protonic-electron conducting cermet membrane in accordance with this invention. The cermet membrane of this invention is made from a first phase of proton-conducting ceramic material capable of diffusing hydrogen ions consisting essentially of perovskite or a comparable material and preferably also including a secondary phase of electron-conducting metallic material. The secondary phase of metallic additive also functions as a sintering aid to lower the fabrication temperature of the cermet membranes of this invention. The cermet membranes of this invention preferably also include a reformation catalyst surface along which a suitable reformation catalyst is coated, adhered or bonded thereby forming a catalyst-membrane subassembly. A catalyst-membrane subassembly is encased in or between a pair of high temperature sustainable shells that incorporate designs to provide sealing, manifolding, expansion support, alternating semi-permeable and non-permeable regions to facilitate the separation of a plurality of reaction/reformation and resultant chambers, delivery of pressurized reformation feedstock, support of the membrane, and withdrawal of product gas, thereby forming a reformation chamber element. A plurality of the such unitized membrane subassemblies or reformation chamber elements may be combined to form a reactor stack in accordance with this invention.

As part of this invention, it has been found that it is possible and useful to add a secondary phase metallic additive to the cermet membranes of this invention to provide the requisite electronic conductivity while also to act as a sintering aid during fabrication and processing. In particular, it is a preferred embodiment of this invention to utilize relatively low melting point transition metals such as copper (Cu) and cobalt (Co) as such secondary phase metallic additive. These additive materials, when properly dispersed in the cermet material at levels of about 1-20 wt %, preferably about 5-10 wt %, have been found to act as a liquid phase sintering aid and to provide the necessary electric conductivity to produce a composite mixed conducting cermet membrane which is especially useful in accordance with this invention, the fabrication being carried out at a lower than usual sintering temperature of about 1400-1600 degrees C., preferably about 1450 degrees C.

A process for reforming, shifting and purifying alcohol or hydrocarbon feedstocks, for example, can be advantageously carried out using a membrane reactor apparatus in accordance with the present invention. Such a process might, in one embodiment, comprise the sequential steps of:
a) heating the interior portion of a membrane reactor or reactor stack to a temperature from about 600 degrees C. to about 1000 degrees C. and, more preferably, to about 700 degrees C.;
b) passing a feedstock and water vapor or a source of water to a reformation side of the mixed conducting cermet membrane at elevated pressure so as to contact a reformation catalyst and form hydrogen/hydrogen ions;
c) diffusing at least a portion of hydrogen/hydrogen ions through the mixed conducting cermet membrane to a lower pressure outlet side of the membrane;
d) releasing the hydrogen collected on the outlet side of the membrane to a collection tank, preferably through a pressure-sensitive release valve with or without the aid of vacuum or purging forces; and,
e) optionally, combusting the reformation purge stream coming from the reformation chamber (typically containing unreacted alcohol or hydrocarbon) to yield supplemental heat for supply to the membrane reactor or reactor stack.
   Based on the forgoing process steps, a number of advantages and improvements over conventional hydrogen reformation systems are realized with the process and apparatus of the present invention including:
1) provides a single integrated and coordinated process and apparatus for the reforming, shifting and purifying reactions or functions;
2) requires no cooling down of intermediate product gas for shifting and purifying reactions or functions;
3) only one catalyst or catalytic surface is necessary for reforming and shifting reactions;
4) cermet membrane can be made very thin for higher permeation performance at least in part because it is structurally sustained by an expansion foil and shell enclosures as further described below;
5) hydrogen purity is optimized;
6) compact size and energy efficient.

### BRIEF DESCRIPTION OF THE DRAWINGS

FIG. 1A is a schematic sectional side view of a planar membrane reactor subassembly according to the present invention.

FIG. 1B is a schematic sectional side view of a planar membrane/catalyst unit according to the present invention.

FIG. 2A is a schematic sectional side view showing the several components in the proper order and spatial relationship of a disassembled multicomponent planar membrane reactor stack according to the present invention.

FIG. 2B is a schematic right (interior) end view of the left end terminating cap unit seen in FIG. 2A.

FIG. 2C is a schematic end view of one of the several membrane/catalyst units shown in FIG. 2A as viewed from the catalyst layer side.

FIG. 3A is a schematic cross-sectional view of a tubular membrane/catalyst unit according to the present invention.

FIG. 3B is an external isometric side view of a tubular membrane reactor assembly according to the present invention.

### DESCRIPTION OF PREFERRED EMBODIMENTS

The present invention discloses a process and apparatus wherein a protonic-electron conducting cermet membrane reactor containing a suitable reformation catalyst thermal-catalytically dissociates an alcohol or hydrocarbon feedstock, typically in the presence of water vapor, to hydrogen-containing gas, continuously withdrawing the hydrogen produced in situ through the membrane to promote the reformation and shifting reactions, and collecting the hydrogen on the other side of the membrane. The cermet membrane of this invention is preferably made of a perovskite material or comparable ceramic oxide material phase represented generally by the chemical formula: ABO₃, where A is preferably selected from the group of metals consisting of the alkaline earth metals and more preferably Ba, Ca, and Sr, and mixtures thereof; B is selected from an element or combination of elements from the periodic table groups of transition metals and metals and more preferably Ce, Eu, Gd, In, La, Mg, Mo, Nd, Sc, Sm, Tm, Y, Yb and Zr and mixtures thereof, preferably in combination with an effective amount to aid in sintering of a electron conductor metal phase selected from the group consisting of palladium, nickel, cobalt, iron, ruthenium, rhodium, osmium, iridium, platinum, titanium, zirconium, hafnium, vanadium, niobium, tantalum, copper, silver, gold, and mixtures thereof, preferably copper, cobalt, nickel or copper/nickel alloys; and 0 represents oxygen. A surface of the cermet membrane on the interior of the reformation chamber as described above is preferably coated with or adhered to a catalyst layer of a reformation catalyst selected from the group consisting of palladium, nickel, cobalt, iron, ruthenium, rhodium, osmium, iridium, platinum, titanium, zirconium, hafnium, vanadium, niobium, tantalum, copper, silver, gold, or mixtures thereof, preferably nickel or copper/nickel. For some embodiments of this invention, the catalyst layer may be further doped with an effective amount to improve hydrogen diffusion and support properties of perovskite ceramic oxide or comparable material.

### EXAMPLE 1

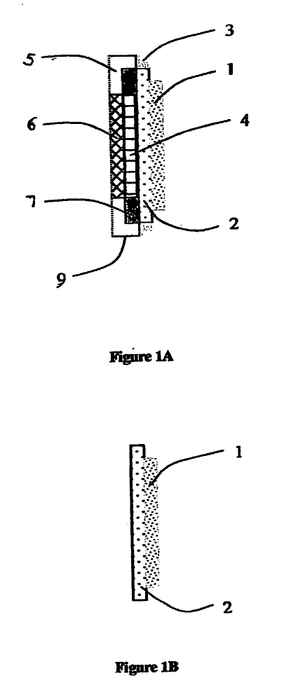

In a preferred embodiment of this invention, protonic ceramic powder consisting essentially of BaCe_{0.5}Zr_{0.4}Y_{0.1}O₃ composition is made using combustion synthesis or a chemical precipitation method. Cupric nitrate is then impregnated into the ceramic powder to reach incipient wetness, typically at a level of about 5 weight % of Cu in the blend. The impregnated powder is then calcined at about 300 degrees C. for about 10 hours. The calcined powder is then blended with suitable binders (such as polyvinyl butyral, B-79), plasticizers (such as butyl benzyl phthalate, S-160), dispersants (such as polyester/polyamide copolymer, KD-1) and solvents (such as combinations of isopropyl alcohol and toluene) and milled for about 12 hours to form a slurry. The slurry is de-aired and pumped into the reservoir of a tape casting machine, where it is casted onto a mylar sheet to form a green tape upon curing of about 0.004 inches (0.1 mm) in thickness. The tape is trimmed to desired dimension, preferably in circular shape and less than 12 inches (30 cm) in diameter, by mechanical or thermal blanking. The blanked tape is then placed onto a firing setter and sintered in air at about 1450 degrees C. for about 3 hours. The sintered cermet membrane 2 (as seen in FIGS. 1A and 1B, for example) is then thinly coated with about 0.002 in (0.05 mm) of porous nickel catalyst paste 1 using a screen printer. The catalyst coated membrane is placed in an air furnace and further sintered at about 1200 degrees C. for about 1 hour.

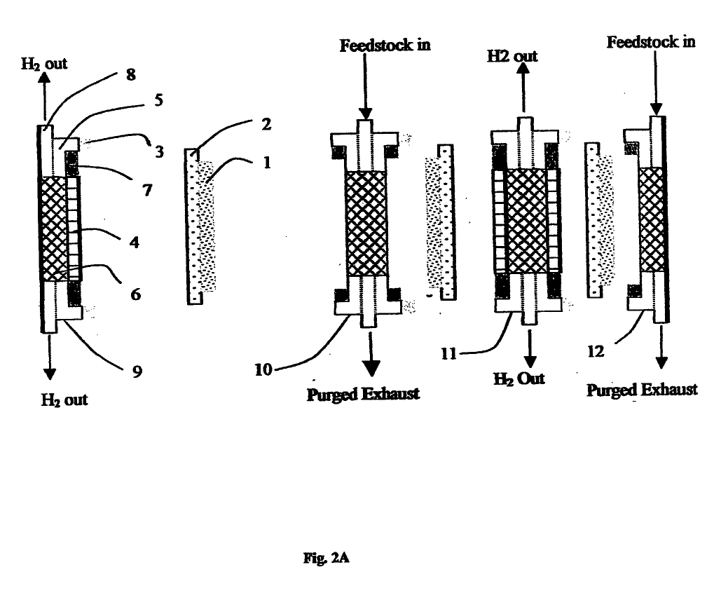

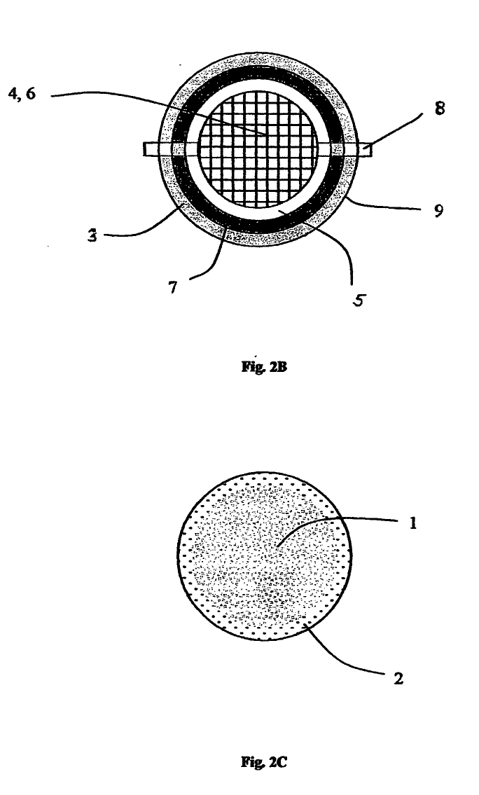

The shell container 9 designed with manifolds 8, semi-permeable region 6 and non-permeable region 5, as seen schematically in FIGS. 1A, 2A and 2B, is preferably fabricated and machined from type 304 stainless steel or a comparable material. The expansion foil 4 may be selected, for example, from one of the non-weaved foil product lines commercially available from Delker Corp., and is trimmed to size. The sealant 3 and 7 may be selected, for example, from one of the group of higher temperature glass sealant pastes commercially available from Ferro Corp. or ceramic-metal adhesives from Cotronics Corp. The assembly of the membrane reactor according to this invention is completed by inserting the expansion foil into the middle of the shell container. Glass or ceramic-metal sealant paste is applied to the perimeter of the expansion foil and the shell container. The catalyst-membrane subassembly is affixed to the top of the expansion foil where it is held in position by the sealant. The matching shell container is positioned and affixed to the assembled shell container and is also held in place by the sealant. The assembled single-cell membrane reactor is then placed into an air furnace and brought up to about 800 degrees C. for about 10 minutes, and thereafter cooled slowly. Multiple-cell membrane reactor units in accordance with this invention may be fashioned by stacking a plurality of the individual shell assemblies such as subassemblies 9, 10, 11, and 12.

Referring again to the drawings, single-cell and multiple-cell cermet membrane reactors according to the present invention are schematically represented in FIGS. 1A and 1B and FIGS. 2A, 2B, and 2C, respectively.

It will be apparent to those skilled in the art that changes and modifications may be made in the above-described apparatus and process for a single-stage membrane reactor for high purity hydrogen production without departing from the spirit and scope of the invention herein, and it is intended that all matter contained in the above description shall be interpreted in an illustrative and not a limiting sense.

### EXAMPLE 2

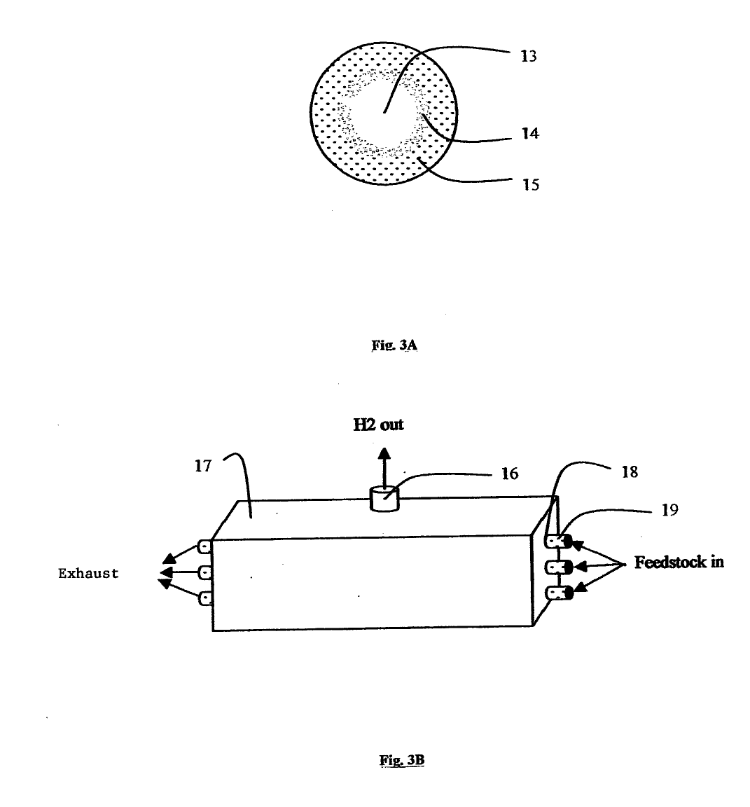

In a second embodiment of this invention, protonic ceramic powder consisting essentially of BaCe_{0.5}Zr_{0.4}Y_{0.1}O₃ composition is made using a combustion synthesis method. Cupric nitrate is then impregnated into the ceramic powder to reach incipient wetness, typically at a level of about 5 weight % of Cu in the blend. The impregnated powder is then calcined at about 300 degrees C. for about 10 hours. The calcined powder is then blended with suitable binders (such as polyvinyl butyral, B-79), dispersants (such as polyester/polyamide copolymer, KD-1) and solvents (such as combinations of isopropyl alcohol and toluene) and mixed to form a paste. The paste is then fed into an extruder containing a die of specific cylindrical opening, preferably less than 2 inches (5 cm) in outer diameter and 20 inches (50 cm) in length with wall thickness of about 0.02 inches (0.5 mm). The extruded green tube is inserted onto a rod shape firing setter and sintered in air at about 1450 degrees C. for about 3 hours. The sintered cermet membrane 15 (for example as shown in FIG. 3A) is then thinly coated on the interior surface with about 0.002 inches (0.05 mm) of porous nickel catalyst paste 14 using a spray gun. The catalyst coated membrane is placed in an air furnace and further sintered at about 1200 degrees C. for about 1 hour.

The catalyst coated membrane tube 19 is inserted through walls of hermetic gas chamber 17 containing product gas manifolds 16 and sealed in place using glass seals or brazes 18, as seen schematically in FIG. 3B. The assembly of the membrane reactor according to this invention is completed by heat melting the seals. Multiple tube membrane reactor units in accordance with this invention may be fashioned by inserting a plurality of tube assemblies 19 through and sealed to gas chamber 17.

Referring again to the drawings, single-tube and multiple-tube type cermet membrane reactors according to the present invention are schematically represented in FIGS. 3A and 3B, respectively.

It will be apparent to those skilled in the art that changes and modifications may be made in the above-described apparatus and process for a single-stage membrane reactor for high purity hydrogen production without departing from the spirit and scope of the invention herein, and it is intended that all matter contained in the above description shall be interpreted in an illustrative and not a limiting sense.

### EXAMPLE 3

In one example of operation of a membrane reactor as described in Example 1 and 2, the entire assembly is heated to a temperature above about 750 degrees C. De-ionized water is introduced into a pressure vessel and heated to above 100 degrees C. The exiting steam is then mixed with desulfurized natural gas at a molecular ratio of 2:1 or 3:1 and this mixed feedstock stream is compressed and regulated at 80 psig. The mixed feedstock stream is channeled to the inlets of the membrane reactors where the exhaust ports are fitted with regulating devices to maintain internal pressure of no less than 80 psig. Hydrogen gas product is suctioned out using a vacuum pump or purged out with pressurized helium gas. Alternatively, metal hydride elements may be incorporated into the product gas chamber to bind with the hydrogen produced in situ. The exhaust or waste gas stream is fed into a burner to generate supplemental heat for the membrane reactor.

Having described the invention, what is claimed is:

1. An apparatus for producing hydrogen from an alcohol or hydrocarbon feed, said apparatus comprising:
(a) a reformation chamber including a feed inlet to an interior region of the chamber, a product outlet from the interior region of the chamber, and a protonic-electron conducting cermet membrane having a first side in the interior region of the chamber and a second side outside the interior region of the chamber;
(b) a porous layer of a reformation catalyst effective to catalyze decomposition of the feed to hydrogen supported by and/or adhered to or adjacent to said first side of the cermet membrane which permits diffusion of ionic hydrogen from said first side thereof through the membrane to said second side thereof; and,
(c) a collection region or chamber on the second side of the membrane where the hydrogen ions can be reconstituted into molecular hydrogen with a supply of electrons.

2. An apparatus according to claim 1 further comprising a heating supply system whereby the reformation chamber can be raised to and maintained at a temperature of between about 600 degrees C. to 1000 degrees C. by an integral fuel burner, said heating supply system comprising a fuel oxidizer, an electric heater, or an imported heat stream.

3. An apparatus according to claim 1 further comprising pressurizing means whereby a reformation feedstock can be compressed to above ambient pressure.

4. An apparatus according to claim 1 wherein the protonic-electron conducting cermet material consists essentially of a proton conducting ceramic phase represented generally by the chemical formula ABO₃ wherein: A is selected from the group of metals consisting of the alkaline earth metals and mixtures thereof; B is selected from an element or combination of elements from the periodic table groups of transition metals and metals in combination with an effective amount of an electron conductor metal phase additive consisting essentially of palladium, nickel, cobalt, iron, ruthenium, rhodium, osmium, iridium, platinum, titanium, zirconium, hafnium, vanadium, niobium, tantalum, copper, silver, gold, and mixtures and alloys thereof;, and, O is oxygen.

5. An apparatus according to claim 4 wherein the metal phase additive is selected so as to also function as a sintering aid.

6. An apparatus according to claim 1 wherein the reformation catalyst is selected from the group of elements consisting of palladium, nickel, cobalt, iron, ruthenium, rhodium, osmium, iridium, platinum, titanium, zirconium, hafnium, vanadium, niobium, tantalum, copper, silver, gold and alloys and mixtures thereof.

7. An apparatus according to claim 6 further wherein the reformation catalyst is blended with an effective amount of a single-phase mixed metal oxide proton conducting material to improve decomposition, support properties, and/or hydrogen ion diffusion.

8. An apparatus according to claim 1 further wherein the catalyst layer is deposited or sintered on at least a surface of the cermet membrane to form a catalyst-membrane subassembly.

9. An apparatus according to claim 8 further wherein a catalyst-membrane subassembly is encased between a pair of metallic, ceramic or cermet containment shells in a planar configuration to form a reformation chamber element.

10. An apparatus according to claim 9 further wherein a reformation chamber element includes o-rings, seals, gaskets or brazes to effect sealing at the inner cavity edge and outer shell edge, a semi-permeable support region with an expansion foil inside the reformation chamber element, and a non-permeable parameter member that includes inlet and/or outlet manifolds.

11. An apparatus according to claim 10 further wherein a plurality of the said reformation chamber elements, each containing a catalyst-membrane subassembly in the cavity, and sealed or adhered to a containment shell to separate the reformation chamber element from a resultant chamber on the second side of the membrane, are bonded hermetically to form a stack that is encased by a terminal shell pair.

12. An apparatus according to claim 11 further wherein the inlet manifolds of the reformation chamber elements are hermetically joined to a fuel feed and the outlet manifolds to a purged exhaust conduit.

13. An apparatus according to claim 11 further wherein manifolds associated with resultant chamber elements are hermetically joined to product gas withdrawal conduits.

14. An apparatus according to claim 13 further including a conduit system whereby a purged reformation stream withdrawn from the reformation chamber elements is diverted to a heating source where it can be combusted to produce heat for the reformation chamber.

15. An apparatus according to claim 8 further wherein a catalyst-membrane subassembly is encased in a metallic, ceramic or cermet containment chamber in a tubular configuration.

16. A method for producing hydrogen from an alcohol or hydrocarbon feed, said method comprising the steps of:
(a) contacting an alcohol or hydrocarbon feed with a reformation catalyst under reformation temperature and reformation pressure conditions effective to decompose at least a portion of the feed into hydrogen and/or hydrogen ions and other decomposition products, said reformation catalyst being coated along or bonded to a surface on a first side of a mixed phase protonic-electron conducting cermet membrane capable of diffusing hydrogen ions;
(b) diffusing at least a portion of the hydrogen ions produced by the feed decomposition of step (a) through the cermet membrane to a second side of the membrane; and,
(c) combining hydrogen ions diffused through the cermet membrane with electrons to reconstitute molecular hydrogen on the second side of the membrane.

17. A method according to claim 16 further wherein said cermet membrane consists essentially of a material having the general chemical formula ABO₃ wherein:
A is selected from the group of metals consisting of the alkaline earth metals;
B is selected from an element or hybrid elements from the periodic table groups of transition metals and metals, in combination with an electron conductor metal phase additive consisting essentially of palladium, nickel, cobalt, iron, ruthenium, rhodium osmium, iridium, platinum, titanium, zirconium, hafnium, vanadium, niobium, tantalum, copper, silver, gold, and mixtures and alloys thereof; and,
O is oxygen.

18. A method according to claim 17 further wherein the reformation catalyst is selected from the group of elements consisting of palladium, nickel, cobalt, iron, ruthenium, rhodium, osmium, iridium, platinum, titanium, zirconium, hafnium, vanadium, niobium, tantalum, copper, silver, gold, and mixtures and alloys thereof.

19. A method according to claim 16 wherein the reformation temperature is between about 600 degrees C. and 1000 degrees C.

20. A method according to claim 16 wherein the reformation pressure is above ambient pressure conditions.
